(19) United States
(12) Patent Application Publication
(10) Pub. No.: US 2026/0226379 A1
(43) Pub. Date: Aug. 6, 2026

(54) Liquid Dishwashing Detergent Composition

(71) Applicant: Reckitt Benckiser Finish B.V., Hoofddorp (NL)

(72) Inventors: Emily Downing, Heidelberg (DE); Michelle Emmerich, Heidelberg (DE); Olga Kaczerewska, Heidelberg (DE); Torsten Roth, Heidelberg (DE); Pavlinka Roy, Heidelberg (DE); Itahisa Suarez, Heidelberg (DE)

(73) Assignee: Reckitt Benckiser Finish B.V., Hoofddorp (NL)

(21) Appl. No.: 19/151,162

(22) PCT Filed: Jan. 24, 2024
(86) PCT No.: PCT/EP2024/051681

§ 371 Date: Jul. 25, 2025

(30) Foreign Application Priority Data
Jan. 26, 2023 (GB) 2301129.9

(51) Int. Cl. C11D 17/04; C11D 1/72; C11D 3/20; C11D 3/22; C11D 3/37; C11D 3/40; C11D 3/43

(52) U.S. Cl. CPC C11D 17/045; C11D 1/72; C11D 3/2079; C11D 3/222; C11D 3/3707; C11D 3/40; C11D 3/43; C11D 2111/14

(57) ABSTRACT

The present invention is related to a liquid dishwashing, preferably an automatic dishwashing, detergent composition comprising at least one liquid non-ionic fatty alcohol alkoxylate surfactant and at least one coloring agent; wherein the detergent composition further comprises at least one rheology modifier; wherein said rheology modifier comprises a dispersion of cellulose in a non-aqueous solvent system. The invention is further related to a dishwashing, preferably an automatic dishwashing, water-soluble container; wherein said water-soluble container is made of a thermoformed water-soluble film comprising poly(vinyl alcohol) and wherein said water-soluble container is at least partially filled with such a liquid, preferably an automatic dishwashing, detergent composition.

### FIELD OF THE INVENTION

The present invention relates to a liquid dishwashing, preferably an automatic dishwashing, detergent composition comprising at least one liquid nonionic fatty alcohol alkoxylate surfactant and at least one coloring agent.

The invention further relates to a dishwashing, preferably an automatic dishwashing, water-soluble container.

### BACKGROUND OF THE INVENTION

Rheology modifiers in general are regularly used across a variety of applications, e.g., in the food, pharmaceutical, household and personal care industries. The aim of using them may be different depending on the desired effects, but would usually include increased emulsion stability, or the ability to suspend other ingredients.

A range of different chemical types of rheology modifiers (and underlying mechanisms) are known today and commercially available: Acrylic polymers, carrageenans, different types of cellulose, silicates or xanthan gums are just some of them.

However, for them, the preferred/recommended solvent system remains water to enable an effect. Unfortunately, as it is well established, water-containing formulations exhibit stability issues when in contact with the water-soluble poly(vinyl alcohol) (PVOH) films used in current automatic dishwashing (ADW) monodose containers (also called pouches as a synonym).

To the best of our knowledge, there is no prior art available either in the patent or academic literature that provides an efficient, cost-effective, and modular solution to the challenges outlined above.

Even when prior commercialized products provided already cellulose-based suspending agents, they have always been used in water, which is found unsuitable for the application at hand due to their incompatibility with the water-soluble and plasticize able PVOH film.

### OBJECTIVE OF THE PRESENT INVENTION

In view of the prior art, it was thus an object of the present invention to provide a dishwashing, preferably an automatic dishwashing, detergent composition, which shall not exhibit the aforementioned shortcomings of the known liquid prior art dishwashing detergent compositions.

In particular, it was an object of the present invention to provide a liquid dishwashing detergent composition, which shall ensure a stable suspension of particles, such as granules, in particular enzyme granules, in a non-aqueous solvent system; while at the same time compatibility with water-soluble poly(vinyl alcohol) (PVOH) films shall be ensured.

Furthermore, it was an object to provide a liquid dishwashing detergent composition, wherein the addition of a suitable rheology modifier should, of course, not result in any undesirable effects, for example on the products Cleaning Performance, Shine Performance, Drying Performance, Material Care properties, storage stability as well as on any aesthetic attributes (a transparent appearance is generally preferred).

Additionally, it was especially an object of the present invention to provide a liquid dishwashing detergent composition, which ideally ensure not only a stable suspension of added granules and a high compatibility with water-soluble poly(vinyl alcohol) (PVOH) films, but at the same time also reduces a potential consumer safety risk associated with an undesired rupture of the water-soluble poly(vinyl alcohol) (PVOH) film and splashing of its content.

Hence, it was an additional object of the present invention to provide a liquid dishwashing detergent composition, which shall have an enhanced viscosity to avoid said splashing of the liquid dishwashing detergent composition.

### SUMMARY OF THE INVENTION

These objects and also further objects which are not stated explicitly but are immediately derivable or discernible from the connections discussed herein by way of introduction are achieved by a liquid dishwashing, preferably an automatic dishwashing, detergent composition having all features of claim 1. Appropriate modifications to the inventive liquid dishwashing, preferably an automatic dishwashing, detergent composition are protected in dependent claims 2 to 13.

Claim 14 relates to a dishwashing, preferably an automatic dishwashing, water-soluble container, which is at least partially filled with such a liquid dishwashing, preferably an automatic dishwashing, detergent composition. Claim 15 is an appropriate modification of such a container.

The present invention accordingly provides a liquid dishwashing, preferably an automatic dishwashing, detergent composition comprising at least one liquid non-ionic fatty alcohol alkoxylate surfactant and at least one coloring agent; wherein the detergent composition further comprises at least one rheology modifier; wherein said rheology modifier comprises a dispersion of cellulose in a non-aqueous solvent system.

It is thus possible in an unforeseeable manner to provide a dishwashing, preferably an automatic dishwashing, detergent composition, which does not exhibit the aforementioned shortcomings of the known prior art dishwashing detergent compositions.

In particular, the liquid dishwashing detergent composition of the present invention ensures a stable suspension of particles, such as granules, in particular enzyme granules, in a non-aqueous solvent system; while at the same time compatibility with water-soluble poly(vinyl alcohol) (PVOH) films is ensured.

Furthermore, the liquid dishwashing detergent composition of the present invention comprising a rheology modifier as claimed does not result in any undesirable effects, for example on the products Cleaning Performance, Shine Performance, Drying Performance, Material Care properties, storage stability as well as on any aesthetic attributes (a transparent appearance is even given).

Additionally, the liquid dishwashing detergent composition of the present invention offers a liquid dishwashing detergent composition, which ensures not only a stable suspension of added granules and a high compatibility with water-soluble poly(vinyl alcohol) (PVOH) films, but at the same time also a reduced potential consumer safety risk associated with an undesired rupture of the water-soluble poly(vinyl alcohol) (PVOH) film and splashing of its content.

Hence, the liquid dishwashing detergent composition of the present invention possesses an enhanced viscosity to avoid said splashing of the liquid dishwashing detergent composition.

### BRIEF DESCRIPTION OF THE TABLES

Objects, features, and advantages of the present invention will also become apparent upon reading the following description in conjunction with the tables, in which:

Table 1 exhibits a prescreening of potential rheology modifiers.

Table 2 exhibits a comparative and an inventive formulation.

Table 3 exhibits cleaning performance results of a comparative and an inventive embodiment.

Table 4 exhibits shine performance results of a comparative and an inventive embodiment.

Table 5 exhibits studies for investigating the most suited amount of Cellulon® WL-D.

Table 6 exhibits a comparison of the dissolution time of a comparative example versus an inventive example comprising 9 wt % of Cellulon® WL-D as a rheology modifier.

Table 7 exhibits a prescreening of potential thickening agents.

Table 8 exhibits viscosity values of mixtures with different ratios of the liquid non-ionic fatty alcohol alkoxylate surfactant of Table 2 and Polyglycol P41/12000 as thickening agent.

Table 9 exhibits a comparative and four inventive formulations.

Table 10 exhibits a comparative and four inventive formulations.

### DETAILED DESCRIPTION OF THE INVENTION

The expression “substantially free” means in the context of the present invention a concentration of less than 5 wt %, preferably less than 3 wt %, and more preferably less than 0.5 wt %.

The expression “non-aqueous solvent system” means in the context of the present invention a solvent system, which comprises at least one non-aqueous solvent.

The expression “thickening agent” means in the context of the present invention a viscosity enhancing compound.

The expression “dispersion” means in the context of the present invention a synonym for a “suspension”; and is used interchangeably herein.

In one embodiment, the cellulose is derived from a microbial fermentation production process.

In one embodiment, the dispersion of cellulose in the non-aqueous solvent comprises 0.5 to 10 wt %, preferably 1 to 7 wt %, and more preferably 2 to 5 wt % of cellulose.

In a preferred embodiment, the dispersion of cellulose in the non-aqueous solvent is transparent.

In one embodiment, the at least one rheology modifier is substantially free, preferably completely free, of a hemicellulose or a lignin.

In one embodiment, the liquid dishwashing, preferably automatic dishwashing, detergent composition comprises 6 to 20 wt %, preferably 7 to 15 wt %, and more preferably 8 to 12 wt % of the rheology modifier.

In one embodiment, the liquid dishwashing, preferably automatic dishwashing, detergent composition further comprises 2 to 20 wt %, preferably 4 to 15 wt %, and more preferably 6 to 10 wt % of at least one enzyme, preferably protease and/or amylase, in particular in form of granules.

In one embodiment, the liquid dishwashing, preferably automatic dishwashing, detergent composition is substantially free, preferably completely free, of water.

In one embodiment, the liquid dishwashing, preferably automatic dishwashing, detergent composition comprises 0.01 to 5 wt %, preferably 0.03 to 1 wt %, and more preferably 0.05 to 0.25 wt % of the at least one coloring agent, preferably a red coloring agent.

In one embodiment, the liquid dishwashing, preferably automatic dishwashing, detergent composition comprises 40 to 90 wt %, preferably 50 to 80 wt %, and more preferably 60 to 70 wt % of the at least one liquid non-ionic fatty alcohol alkoxylate surfactant.

In another embodiment, the liquid dishwashing, preferably automatic dishwashing, detergent composition comprises at least 20 wt %, preferably at least 40 wt %, and more preferably at least 60 wt % of the at least one liquid non-ionic fatty alcohol alkoxylate surfactant.

In one embodiment, the non-aqueous solvent system comprises a propylene glycol and/or a polyethylene glycol; wherein the propylene glycol has preferably a molecular weight higher than 100 g/mol, wherein more preferably the propylene glycol is di-propylene glycol or tri-propylene glycol, and wherein most preferably the propylene glycol is di-propylene glycol; and wherein the polyethylene glycol is preferably PEG200 or PEG400.

In an alternative embodiment hereto, the non-aqueous solvent system consists of a propylene glycol or a polyethylene glycol; wherein the propylene glycol has preferably a molecular weight higher than 100 g/mol, wherein more preferably the propylene glycol is di-propylene glycol or tri-propylene glycol, and wherein most preferably the propylene glycol is di-propylene glycol; and wherein the polyethylene glycol is preferably PEG200 or PEG400.

In one embodiment, the liquid dishwashing, preferably automatic dishwashing, detergent composition further comprises 6 to 50 wt %, preferably 8 to 42 wt %, and more preferably 12 to 33 wt % of at least one thickening agent.

In a preferred embodiment thereof, the thickening agent is selected from the group consisting of an ethylene/propylene oxide copolymer, a salt of a saturated fatty acid, and a fumed silica; wherein the thickening agent is preferably sodium stearate or an ethylene/propylene oxide copolymer having a mole ratio of 1:1 to 10:1, preferably of 3:1 to 5:1, and more preferably of 4:1 of ethylene oxide to propylene oxide.

In the context of the present invention has been generally found that a weight average molecular weight of the ethylene/propylene oxide copolymer ranging from 6 000 to 30 000 g/mol, preferably from 8 000 to 20 000 g/mol, and more preferably from 10 000 to 15 000 g/mol is suitable.

In another preferred embodiment thereof, the liquid dishwashing, preferably automatic dishwashing, detergent composition comprises the at least one liquid non-ionic fatty alcohol alkoxylate surfactant and the thickening agent in a weight % ratio of 80:20 to 30:70, preferably of 75:25 to 40:60, and more preferably of 70:30 to 50:50.

Further, the object of the present invention is also solved by a dishwashing, preferably an automatic dishwashing, water-soluble container; wherein said water-soluble container is made of a thermoformed water-soluble film comprising poly(vinyl alcohol) and wherein said water-soluble container is at least partially filled with a liquid dishwashing, preferably an automatic dishwashing, detergent composition according to one of the preceding claims.

In a preferred embodiment thereof, said water-soluble container comprises at least a first compartment and at least a, from the first compartment separated, second compartment; wherein said at least first compartment is at least partially filled with a liquid dishwashing, preferably an automatic dishwashing, detergent composition according to one of the preceding claims; and wherein preferably said water-soluble container further comprises at least a third compartment separated from the first and the second compartment; and wherein more preferably said at least second compartment is at least partially filled with a powder dishwashing, preferably an automatic dishwashing, detergent composition while said at least third compartment is at least partially filled with a dishwashing gel.

The present invention thus addresses the problem of providing a liquid dishwashing, preferably an automatic dishwashing, detergent composition, which ensures not only a stable suspension of added granules and a high compatibility with water-soluble poly(vinyl alcohol) (PVOH) films, but at the same time also reduces a potential consumer safety risk associated with an undesired rupture of the water-soluble poly(vinyl alcohol) (PVOH) film and splashing of its content by having an enhanced viscosity.

The following non-limiting examples are provided to illustrate an embodiment of the present invention and to facilitate understanding of the invention, but are not intended to limit the scope of the invention, which is defined by the claims appended hereto.

### Experimental Part:

First, a prescreening of potential rheology modifiers was conducted in beakers. Herein, all experiments have been done by adding the same amount of a possible rheology modifier in wt %, namely 10 wt %, to a liquid automatic dishwashing detergent composition comprising 81.87 wt % of one liquid non-ionic fatty alcohol alkoxylate surfactant, 0.13 wt % of one red coloring agent, and 8 wt % of amylase enzyme granules.

TABLE 1
Prescreening of potential rheology modifiers.

| Rheology | Stable | Transparent | Stable in a |
|---|---|---|---|
| Modifier | Suspension | Appearance | PVOH pouch |
| Acusol Millenium ER | No | No | No |
| Acusol Millenium ER + | Yes | No | No |
| Sorbitol | | | |
| Acusol 805S | Yes | No | n/a |
| Cellulon ® WL | Yes | Yes | Yes |
| Cellulon ® WL-D | Yes | Yes | Yes |
| Cellulon ® R27 | No | Yes | n/a |
| Sodium Stearate | No | Yes | Yes |
| Lutensol AT25 | No | No | n/a |
| Aerosil 300 | No | Yes | Yes |
| Carragenans | No | Yes | n/a |
| Polyglycol P41/12000 | No | Yes | Yes |
| Xanthan Gum | No | No | n/a |

Only selected options were considered for the subsequent evaluation in thermoformed PVOH pouches. A “n/a” in Table 1 denotes that a raw material was not included in this part. A “no” in the column “stable suspension” of Table 1 means that the amylase enzyme granules are unsuspended and dissolved.

As can be easily derived from Table 1, the prescreening has resulted in Cellulon® WL (a dispersion of cellulose, which is derived from a microbial fermentation production process, in mono-propylene glycol) and Cellulon® WL-D (a dispersion of cellulose, which is derived from a microbial fermentation production process, in di-propylene glycol) are the best candidates for the purpose of the invention in this selective liquid automatic dishwashing detergent composition.

However, storage stability assessments of both Cellulon® compounds as rheology modifier has been executed subsequently. Herein, no issues were observed with the granules suspending capacity or with transparency, even after 12 weeks of storage stability (12 weeks, 30° C. at 65% room humidity; or 12 weeks, 40° C. at 75% room humidity).

However, it has to be mentioned that a new issue emerged during the storage stability assessment, namely that with Cellulon® WL some of the PVOH pouches were found deformed and displayed visible wrinkles already after 3 weeks at the different storage conditions. This issue has not been observed with Cellulon® WL-D.

Conclusively, further storage stability assessments have been done in order to evaluate if other solvents instead of mono-propylene glycol are better suited for the purpose of the invention.

Therefore, the same amount of the same cellulose compound as in Cellulon® WL has been dispersed once in di-propylene glycol (Cellulon® WL-D) and once in PEG 200 (called herein now Cell-PEG200).

Cellulon® WL-D has been tested for 12 weeks at 5° C./50% r.h.; at 25° C./50% r.h.; at 30° C./65% r.h.; and at 40° C./75% r.h.

Cell-PEG200 has been tested for 4 weeks and for 12 weeks at 25° C./50% r.h.; at 30° C./65% r.h.; and at 40° C./75% r.h. each.

All experiments formed a stable transparent suspension.

The samples prepared with Cellulon® WL-D did not change over the duration of the storage stability assessment. Even after 12 weeks, the liquid remained transparent, active granules were still suspended and no changes to the PVOH film covering the PVOH compartment of the liquid dishwashing detergent composition were observed.

For samples prepared with Cell-PEG200, the suspension of the granules remained stable after 12 weeks of storage at different conditions. Although the liquid was still transparent after 3 weeks at 30° C./65% r.h. and 40° C./75% r.h., the PVOH foil on the compartment of the liquid dishwashing detergent composition became more elastic, suggesting a weak plasticizing effect of the PEG200. This was observed for more than half of the pouches stored in each condition. After 5 weeks at 40° C./75% r.h., a wrinkle was very visible and the PVOH foil of said compartment of the PVOH pouch was markedly deformed.

Based on the results of the storage stability assessment, Cellulon® WL-D is regarded finally as the most preferred embodiment of the present invention as it was found more compatible with the PVOH film.

In a further experiment, an automatic dishwashing water-soluble container comprising a first compartment and a, from the first compartment separated, second compartment; wherein said first compartment is completely filled with an inventive liquid automatic dishwashing detergent composition according to the present invention; and wherein said water-soluble container further comprises a third compartment separated from the first and the second compartment; and wherein said second compartment is completely filled with a powder automatic dishwashing detergent composition while said third compartment is completely filled with a dishwashing gel.

Herein, the automatic dishwashing water-soluble container used is a commercial product of the applicant, namely Finish® Quantum, in which the red liquid automatic dishwashing detergent composition has been replaced by the inventive composition.

The white powder and the blue dishwashing gel in the respective second and third compartment has remained unchanged.

Table 2 shows the comparison between the red liquid dishwashing detergent composition of the commercial product Finish® Quantum and the inventive composition using Cellulon® WL-D as additional rheology modifier.

Herein, a part of Cellulon® WL-D has been exchanged with an additional thickening agent, namely Polyglycol P41/12000, in order to further enhance the viscosity of the liquid dishwashing detergent composition for avoiding the so-called “splashing effect”.

Thereby, consumer safety is further improved.

TABLE 2
Comparative and inventive formulation.

| | | Comparative | | Inventive | |
|---|---|---|---|---|---|
| Ingredient | Function | Example | | Example | |
| Liquid non-ionic fatty | Surfactant | 99.87 | wt % | 58.01 | wt % |
| alcohol alkoxylate | | | | | |
| Red coloring agent | Coloring | 0.13 | wt % | 0.13 | wt % |
| | agent | | | | |
| Cellulon ® WL-D | Rheology | — | | 9 | wt % |
| | modifier | | | | |
| Polyglycol P41/12000 | Thickening | — | | 24.86 | wt % |
| | agent | | | | |
| Amylase | Enzyme | — | | 8 | wt % |
| | granules | | | | |

In the following shine and cleaning performance experiment have been analyzed with PVOH pouches being once the commercial product of the applicant as given above as comparative example and once as inventive PVOH pouch in which the liquid dishwashing detergent composition is amended as given in Table 2.

TABLE 3
Cleaning performance results, wherein 10
is the best performance and 1 the worst.
CP IKW - 1 h 65

| | | | | | | Tea | | |
|---|---|---|---|---|---|---|---|---|
| | Crème | Milk | Minced | | | with | Starch | Egg |
| | Brulee | Skin | Meat | Pasta | Tea | Milk | Mix | Yolk |
| Comp. | 10.0 | 9.9 | 10.0 | 9.0 | 9.8 | 10.0 | 10.0 | 9.6 |
| Inven- | 10.0 | 9.9 | 10.0 | 9.1 | 9.8 | 10.0 | 10.0 | 9.3 |
| tive | | | | | | | | |

TABLE 4
Shine performance results, wherein 1 is
the best performance and 5 is the worst.

| | |
|---|---|
| Comparative Example | Inventive Example |

| | Spotting | Filming | Spotting | Filming |
|---|---|---|---|---|
| Short | | | | |
| G | 2 | 3.8 | 2 | 3.9 |
| SS | 2 | 3.5 | 2 | 3.5 |
| PO | 2 | 3 | 2 | 3 |
| PP | 5 | 2 | 5 | 2 |
| Long | | | | |
| G | 2.1 | 3.4 | 2 | 3.4 |
| SS | 2 | 3 | 2 | 3 |
| PO | 2 | 3.5 | 2 | 3.5 |
| PP | 5 | 4 | 5 | 4 |

Both Tables 3 and 4 show comparable results and no negative impact after introducing Cellulon® WL-D.

Further experiments for determining the suitable amount of Cellulon® WLD has been carried out in the following:

Rheometer Anton Paar Physica MCR 301 was always used to investigate the rheology of the samples in the experimental part of the present invention at a temperature of 25° C. Correlation between shear rate and shear stress was plotted following the equipment manual instruction. Yield stress was determined from the obtained graph (correlation shear rate vs shear stress).

The viscosity has been always measured by a Brookfield DV-II+ equipment at a temperature of 25° C. if said parameter had been determined in the experimental part of the present invention. Herein, the measurement of viscosity with the Brookfield instrument is based on the determination of the shear stress needed to win the resistance of a fluid by rotation of a spindle. Varying the spindle size, it is possible to cover a wide range of viscosities. Varying the speed of rotation, it is possible to study the rheological behaviour of the fluid.

TABLE 5
Amount of Cellulon ® WL-D.

| wt % of | Enzyme granules | Viscosity | Yield stress |
|---|---|---|---|
| Cellulon ® WL-D | suspended? | [mPas] | [Pa] |
| 10 | Yes | 5900 | 2.62 |
| 9 | Yes | 4500 | 2.45 |
| 7 | Separation started | 4100 | 1.15 |
| | after 4 weeks | | |
| 5 | No | 3850 | 1.12 |

The same inventive composition has been taken as outlined in Table 2. If the Cellulon® WL-D is decreased from 10 wt % to 5 wt %, the amount of the liquid non-ionic fatty alcohol alkoxylate surfactant is respectively increasing by the same amount to equal it out.

At first, the liquid dishwashing detergent composition were kept for observation in glass jars as it allowed a faster observation of phase separation. The sample with 5% Cellulon® WL-D started separating already after a few hours and was therefore not further investigated. For each iteration of the liquid dishwashing detergent composition, viscosity and yield stress were measured since viscosity is an important factor from a safety point of view (splashing).

It was found that the higher the value of the yield stress is, the more stable the suspension is obtained.

Liquid dishwashing detergent compositions having 7 and 9 wt % of Cellulon® WL-D were used to prepare PVOH pouches which were set in storage stability assessments for up to 12 weeks as follows:
9 wt % of Cellulon® WL-D has been tested for 12 weeks at 25° C./50% r.h.; at 30° C./65% r.h.; and at 40° C./75% r.h.
7 wt % of Cellulon® WL-D has been tested for 3 and for 12 weeks respectively at 5° C./50% r.h.; at 25° C./50% r.h.; at 30° C./65% r.h.; and at 40° C./75% r.h.

The sample comprising 9 wt % of Cellulon® WL-D remained stable and no separation was visible. The liquid dishwashing detergent composition remained transparent, and the PVOH film was not modified.

In contrast, the sample comprising 7 wt % of Cellulon® WL-D started separating already after 4 weeks at all tested conditions.

Further dissolution experiments have been carried out using an inventive liquid automatic dishwashing detergent composition according to the inventive example of Table 2. As comparative example, the same comparative example as given in Table 2 has been used.

The dissolution test was conducted at 40° C. according to the test method D0027699. The values in Table 6 are an average of 10 measurements.

TABLE 6
Comparison of the dissolution time of a comparative
example versus an inventive example comprising 9
wt % of Cellulon ® WL-D as a rheology modifier.

| | Start of release | End of release/dissolution |
|---|---|---|
| Comparative example | 5 sec | 1:40 min |
| Inventive Example | 5 sec | 1:43 min |

The test method D0027699 has been executed according to the following steps:
Heat a water bath up to 40° C.
Fill the respectively required number of beakers (depending on the number of examples), herein two, with 900 ml of 40° C. tap water and place them into the water bath
Prepare two separate PVOH pouch compartment filled once with the inventive composition of the inventive example and filled once with the comparative composition of the comparative example.
Place both filled PVOH compartments separated from each other in an individual beaker in the water bath, respectively.
Test the dissolution of the PVOH compartments by recording the time when the release starts and when it ends (when it is fully dissolved)

Both PVOH compartments started releasing their content at the same time, after roughly 5 seconds (average of 10 individual runs). The end of the release was equally reached at roughly the same time. This means that changing the composition and rheology of the liquid automatic dishwashing detergent composition does not negatively impact its dissolution time—a critical factor that may affect a formulations performance.

### Selection of a Thickening Agent for the Liquid Automatic Dishwashing Composition

First, a prescreening of potential thickening agents was conducted. Herein, all experiments have been done by adding the same amount of a possible thickening agent in wt %, namely 16.38 wt %, to a liquid automatic dishwashing detergent composition comprising 83.49 wt % of one liquid non-ionic fatty alcohol alkoxylate surfactant, and 0.13 wt % of one red coloring agent.

The resulting liquid automatic dishwashing detergent compositions have been analyzed for their thickness (provision of a sufficiently high viscosity to avoid any undesired splashing effects), their transparency, their stability versus a PVOH foil from which a PVOH compartment of a PVOH pouch is generally manufactured and for possible issues in their manufacturing (MoM: method of manufacture). A “n/a” in Table 7 denotes that a raw material was not included in this part.

TABLE 7
Prescreening of potential thickening agents.

| Thickening | Viscosity | | Stable in a | MoM |
|---|---|---|---|---|
| Agent | Sufficient? | Transparent? | PVOH pouch | Issues |
| Polyglycol | Yes | Yes | Yes | No |
| P41/12000 | | | | |
| Aerosil 300 | Yes | Yes | Yes | No |
| Sodium Stearate | Yes | Yes | Yes | Yes |
| Crystasense HP5 | Yes | Yes | No | Yes |
| Hedipin R-2000/G | No | No | No | n/a |
| Cellosize QP 100 | No | No | No | n/a |
| Carbopol | No | No | No | n/a |
| Ultrez 30 | | | | |
| Supracare | No | No | No | n/a |
| 780 HCG | | | | |
| PEG 1500 | No | No | No | n/a |

As can be easily derived from Table 7, the prescreening has resulted in solely the first three bold highlighted components as promising thickening agents for the purpose of the invention in this selective liquid automatic dishwashing detergent composition.

Herein, sodium stearate has the disadvantage of a more complicated method of manufacture (MoM) which required separate preparation of a molten sodium stearate premix and heating the nonionic surfactant up to 60° C.

The applicant has chosen for internal business reasons to continue his experimental work with Polyglycol P41/12000 as the most preferred thickening agent for the selective inventive liquid automatic dishwashing detergent composition.

### Methods for Investigating Splashing

As per our knowledge, there has been no official method described to evaluate the splashing behavior of thermoformed ADW products comprising liquid compartments in the dishwashing business. After identifying a suitable thickening agent for adjusting the viscosity over a wide range, the next step was to create a robust method which would closely replicate the real-world scenario while also providing reproducibility and validation of potential options.

The first test method (catted “Droplet Method”) created in our lab was based on tests where the liquid PVOH compartment was pressured with a metal block (weight of 1.5 kg=15N), while a droplet of water was applied (10 μL) and the subsequent splashing behaviour was observed.

The method was used for investigating the relationship between different ratios of surfactant and thickening agent and their splashing behaviour.

Within these tests, “splashing” was—for practical purposes—defined as any splashing event with a distance >10 cm, otherwise the splashing was categorized as “non-splashing”. The distance was chosen based on a distance from handling to eye area. Holding a pouch 20 cm from the eye area makes the PVOH pouch blurry in vision. Bringing it closer, moves it to the cross-eyed region meaning that consumers would rather not to handle the pouches that close.

TABLE 8
Viscosity of mixtures with different ratios of the liquid
non-ionic fatty alcohol alkoxylate surfactant of Table
2 and Polyglycol P41/12000 as thickening agent.

| Ratio of surfactant | Number of splashing | Viscosity |
|---|---|---|
| to thickening agent | incidents (out of 10) | [mPas] |
| 100/0 | 8 | 55 |
| 90/10 | 7 | Not measured |
| 80/20 | 3 | Not measured |
| 70/30 | 2 | 1370 |
| 60/40 | 0 | 3520 |
| 50/50 | 0 | Not measured |

The splashing data in Table 8 shows, that inclusion of the thickening agent via a dose response study gradually decreased the number of splashing incidents. At a ratio of 60/40 of surfactant and Polyglycol P41/12000 no splashing was observed anymore following the ‘Droplet Method’, Moreover, the test also confirmed the relationship between viscosity and splashing behaviour: the higher the viscosity, the lower the risk of the sample to splash.

When correlating the viscosity with the number of the splashed samples, it was assumed that reaching a viscosity equal or higher than ca. 3500 mPas effectively mitigates the risk of splashing significantly.

In the next step, the ‘Droplet Method’ was employed to choose the most appropriate amount of such a thickening agent for an inventive liquid automatic dishwashing detergent composition as given in Table 2, which further comprises enzyme granules and the respective selective rheology modifier.

The following liquid automatic dishwashing detergent compositions has been tested:

TABLE 9
Comparative and inventive formulation.

| | | Comp. | Inv. | Inv. | Inv. | Inv. |
|---|---|---|---|---|---|---|
| Ingredient | Function | Ex. | Ex. | Ex. | Ex. | Ex. |
| Liquid | Surfactant | 99.87 | 65.49 | 57.31 | 49.12 | 40.93 |
| non-ionic fatty | | wt % | wt % | wt % | wt % | wt % |
| alcohol | | | | | | |
| alkoxylate | | | | | | |
| Red coloring | Coloring | 0.13 | 0.13 | 0.13 | 0.13 | 0.13 |
| agent | agent | wt % | wt % | wt % | wt % | wt % |
| Cellulon ® | Rheology | — | 10 | 10 | 10 | 10 |
| WL-D | modifier | | wt % | wt % | wt % | wt % |
| Polyglycol | Thickening | — | 16.38 | 24.56 | 32.75 | 40.93 |
| P41/12000 | agent | | wt % | wt % | wt % | wt % |
| Amylase | Enzyme | — | 8 | 8 | 8 | 8 |
| | granules | | wt % | wt % | wt % | wt % |
| Ratio | — | 100/0 | 80/20 | 70/30 | 60/40 | 50/50 |
| surfactant/ | | | | | | |
| thickening | | | | | | |
| agent | | | | | | |

In addition, to obtain more quantitative results, an additional method with the burst force machine (Ametek DFS-500 Chatillon TCM350) as created was executed. Employing the ‘Burst Force Method’ allowed to record and compare the value of the force needed for samples to burst. The volume of the dosed water droplet is the same as in the formerly discussed ‘Droplet Method’. After dosing of the water droplet, a force is exerted on the centre of the filled PVOH compartment with the stamp of the burst force machine until the filled PVOH compartment bursts. The splashing behaviour is observed, and the distance of any splashing is measured.

Within Table 10, all compositions of Table 9 has been tested in comparison for their splashing behaviour according to the ‘Droplet Method’ and the ‘Burst Force Method’ compared with the viscosity. Overall, a higher viscosity leads to a clear reduction in splashing incidents (‘Droplet Method’) and a reduced splash distance (‘Burst Force Method’).

The following liquid automatic dishwashing detergent compositions of Table 9 has been tested; wherein a comparison is given for the splashing behaviour of these compositions having different ratios of surfactant to thickener. In general, a burst force of 400-550 N is sufficient to achieve the splashing to occur.

TABLE 10
Comparative and inventive formulation.

| Impact of ratio | | | | | |
|---|---|---|---|---|---|
| surfactant/ | Comp. | Inv. | Inv. | Inv. | Inv. |
| thickening agent | Ex. | Ex. | Ex. | Ex. | Ex. |
| Viscosity | 100 | 3600 | 5050 | 6900 | 9750 |
| [mPas] | | | | | |
| Drop method | 11 | 2 | 1 | 0 | 0 |
| Number of splashed | | | | | |
| samples (out of 25) | | | | | |
| ‘Burst Force Method’ | 12.9 | 4.3 | 4.5 | 3.2 | 2.8 |
| Splash distance [cm] | | | | | |

Conclusively, a thickening agent for surfactant-based, transparent, stable, liquid automatic dishwashing detergent compositions was found that mitigate the risk of splashing incidents of thermoformed products thus improving the safety of the product. Moreover, the results were validated employing two newly developed and broadly applicable test methods, which, generally, aim to mimick the shear rate regimes encountered in rupturing PVOH pouches and are linked to the viscosities.

The test methods described herein rely on an applied pressure to force the bursting of the respective PVOH compartment.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the appended claims.

1. A liquid dishwashing detergent composition comprising at least one liquid non-ionic fatty alcohol alkoxylate surfactant and at least one coloring agent, characterized in that the detergent composition further comprises at least one rheology modifier; wherein the at least one rheology modifier comprises a dispersion of cellulose in a non-aqueous solvent system.

2. The liquid dishwashing, detergent composition according to claim 1 characterized in that the cellulose is derived from a microbial fermentation production process.

3. The liquid dishwashing, detergent composition according to claim 1 characterized in that the dispersion of cellulose in the non-aqueous solvent comprises 0.5 to 10 wt % of cellulose.

4. The liquid dishwashing, detergent composition according to claim 1 characterized in that the at least one rheology modifier is substantially free of a hemicellulose or a lignin.

5. The liquid dishwashing, detergent composition according to claim 1 characterized in that the liquid dishwashing detergent composition comprises 6 to 20 wt % of the at least one rheology modifier.

6. The liquid dishwashing, detergent composition according to claim 1 characterized in that the liquid dishwashing detergent composition further comprises 2 to 20 wt % of at least one enzyme.

7. The liquid dishwashing, detergent composition according to claim 1 characterized in that the liquid dishwashing detergent composition is substantially free of water.

8. The liquid dishwashing, detergent composition according to claim 1 characterized in that the liquid dishwashing detergent composition comprises 0.01 to 5 wt % of the at least one coloring agent.

9. The liquid dishwashing, detergent composition according to claim 1 characterized in that the liquid dishwashing detergent composition comprises 40 to 90 wt % of the at least one liquid non-ionic fatty alcohol alkoxylate surfactant.

10. The liquid dishwashing, detergent composition according to claim 1 characterized in that the non-aqueous solvent system comprises a propylene glycol and/or a polyethylene glycol.

11. The liquid dishwashing, detergent composition according to claim 1 characterized in that the liquid dishwashing detergent composition further comprises 6 to 50 wt % of at least one thickening agent.

12. The liquid dishwashing, detergent composition according to claim 11 characterized in that the at least one thickening agent is selected from the group consisting of an ethylene/propylene oxide copolymer, a salt of a saturated fatty acid, and a fumed silica.

13. The liquid dishwashing, detergent composition according to claim 11 characterized in that the liquid dishwashing detergent composition comprises the at least one liquid non-ionic fatty alcohol alkoxylate surfactant and the at least one thickening agent in a weight % ratio of 80:20 to 30:70.

14. A dishwashing, preferably an automatic dishwashing, water-soluble container characterized in that said water-soluble container is made of a thermoformed water-soluble film comprising poly(vinyl alcohol) and wherein said water-soluble container is at least partially filled with the liquid dishwashing detergent composition according to claim 1.

15. The dishwashing water-soluble container according to claim 14 characterized in that said water-soluble container comprises a first compartment and a second compartment separated from the first compartment; wherein said first compartment is at least partially filled with the liquid dishwashing detergent composition according to claim 1.

16. The liquid dishwashing detergent composition according to claim 1 characterized in that said liquid dishwashing detergent composition is an automatic dishwashing detergent composition.

17. The liquid dishwashing detergent composition according to claim 11 characterized in that the at least one thickening agent is sodium stearate or an ethylene/propylene oxide copolymer having a mole ratio of 1:1 to 10:1 of ethylene oxide to propylene oxide.

18. The dishwashing water-soluble container according to claim 14, characterized in that said dishwashing water-soluble container is an automatic dishwashing water-soluble container.

19. The dishwashing water-soluble container according to claim 15, wherein said water-soluble container further comprises a third compartment separated from the first and the second compartments.

20. The dishwashing water-soluble container according to claim 19, wherein said second compartment is at least partially filled with a powder dishwashing detergent composition while said third compartment is at least partially filled with a dishwashing gel.
